(19) United States
(12) Patent Application Publication
(10) Pub. No.: US 2025/0217843 A1
(43) Pub. Date: Jul. 3, 2025

(54) OPTIMIZING A MEDIA CAMPAIGN WITH SUB-DESIGNATED MARKET AREA ZONES AND WEIGHTED MEDIA CHANNELS AND AUDIENCES

(71) Applicant: QUAD/GRAPHICS, INC., SUSSEX, WI (US)

(72) Inventor: Earl Potter, Oconomowoc, WI (US)

(73) Assignee: QUAD/GRAPHICS, INC., SUSSEX, WI (US)

(21) Appl. No.: 18/218,377

(22) Filed: Jul. 5, 2023

Related U.S. Application Data
(60) Provisional application No. 63/392,344, filed on Jul. 26, 2022.
(60) Provisional application No. 63/394,669, filed on Aug. 3, 2022.

(51) Int. Cl. G06Q 30/0242; G06F 3/0482; G06F 3/0483; G06F 3/0484; G06F 3/12; G06Q 30/0241

(52) U.S. Cl. CPC G06Q 30/0244; G06F 3/0482; G06F 3/0483; G06F 3/0484; G06F 3/1296; G06Q 30/0249

(57) ABSTRACT

A system and method for optimizing a media campaign comprises using a solver on various input data to generate a media campaign solution that meets one or more optimization goals. An optimization program comprising the solver generates a media campaign solution based on store location data, trade areas, audience definitions, audience weights, medial channel data and one or more constraints. Each media campaign solution can include spend data for each of a plurality of the media channels.

### CROSS-REFERENCE TO RELATED APPLICATIONS

The present application claims the benefit of U.S. Provisional Application No. 63/392,344 filed Jul. 26, 2022 and U.S. Provisional Application No. 63/394,669 filed Aug. 3, 2022, both of which are incorporated by reference herein in their entireties.

### BACKGROUND

The present application relates to systems and methods for optimizing a media campaign.

Media campaigns can use multiple media channels, such as print, radio, cable television, etc. Marketing departments are tasked with maximizing reach and frequency with a limited budget.

One approach to optimizing a media campaign is to start with a previous year's campaign and make discrete adjustments based on an ad hoc assessment of what went well and what could be improved. However, this approach relies too heavily on human biases and error. Another approach is to use a media mix model which may show what has worked well in the past, but does not account for the possibility of using new media channels not previously used and has other limitations. A third approach is to use a planning tool based on syndicated data from many advertisers. However, such planning tools lack geographic specificity and have other limitations.

### SUMMARY

A method of optimizing a media campaign comprises receiving store location data for a plurality of retail stores and receiving trade areas for each of the plurality of retail stores. The method further comprises receiving an audience definition comprising a plurality of audience members and respective audience location data and receiving audience weights. The method further comprises receiving media channel data for a plurality of media channels, each media channel comprising a cost for the media channel, a geographic region for the media channel, and a weight for the media channel. The method further comprises receiving a constraint, wherein the constraint is selected from the group comprising a budget, a channel frequency, and a buying rule. The method further comprises generating a media campaign solution based on the store location data, trade areas, audience definition, audience weights, medial channel data and the constraint, each media campaign solution comprising spend data for each of the plurality of the media channels. The method further comprises displaying the spend data for each solution on a display screen.

### DESCRIPTION OF THE DRAWINGS

FIG. 1 is a flow diagram of a system and method for optimizing a media campaign, according to an exemplary embodiment;

FIG. 1A is a flowchart of a method of optimizing a media campaign, according to an exemplary embodiment;

FIG. 2 is a portion of a map illustrating Designated Marketing Areas, according to an exemplary embodiment;

FIG. 3 is a diagram showing a retail store location, a trade area around the retail store location, and geographic coverage areas of two hypothetical media products, according to an exemplary embodiment.

FIG. 4 is a diagram showing inputs for an example use of the system and method of optimizing a media campaign, according to an exemplary embodiment;

FIG. 5 is set of pie charts and a graph illustrating an output of the system and method of optimizing a media campaign, according to the exemplary embodiment of FIG. 4;

FIG. 6 is a diagram showing a retail store location, a trade area around the retail store location, and geographic coverage areas of a plurality of media channels and media products, as well as model inputs and a recommendation, according to the exemplary embodiment of FIG. 4;

FIG. 7 is a screenshot of a user interface screen showing a Channels page, according to an exemplary embodiment;

FIG. 8 is a screenshot of a user interface screen showing a Media Options page, according to an exemplary embodiment;

FIG. 9 is a screenshot of a user interface screen showing an Audience Weight page, according to an exemplary embodiment;

FIG. 10 is a screenshot of a user interface screen showing an Overlap page, according to an exemplary embodiment;

FIG. 11 is a screenshot of a user interface screen showing a Data Summary page, according to an exemplary embodiment;

FIG. 12 is a screenshot of a user interface screen showing a Control Panel page, according to an exemplary embodiment; and

FIG. 13 is a screenshot of a user interface screen showing a Summary page, according to an exemplary embodiment.

FIG. 14 is a screenshot of a user interface screen showing a Summary page, according to an exemplary embodiment.

FIG. 15 is a screenshot of a user interface screen showing a Media Spend page, according to an illustrative embodiment.

FIG. 16 is a screenshot of a user interface screen showing a Media Spend DMA Detail, according to an illustrative embodiment.

FIG. 17 is a screenshot of a user interface screen showing a Media Reach and Impressions page, according to an illustrative embodiment.

### DETAILED DESCRIPTION OF ILLUSTRATIVE EMBODIMENTS

The present application describes systems and methods of optimizing a media campaign on a sub-DMA (Designated Market Area) level. The system and method may utilize weighted audiences and/or weighted media channels.

The present application describes systems and methods of maximizing effective reach subject to characteristics of each market and to constraints provided by media suppliers/publishers for each market, the constraints comprising one or more of a budget constraint, a frequency for a media channel, etc.

The present application describes systems and methods for modeling the movement of advertising dollars from one set of media channels to another set of medial channels to improve effective reach of one or more target audiences.

The present application describes systems and methods of identifying an improved set of media channels and media products to be assigned to one or more target audiences and a set of overlapping coverage areas based on product rules and budgetary constraints to improve or maximize effective reach.

The present application describes systems and methods that may improve or maximize effective reach subject to the idiosyncrasies of each market and the constraints imposed by media suppliers/publishers in those markets, along with the advertising entity's budget constraints and/or strategic imperatives.

The present application can provide one or more solutions to the enormously complex problem of optimizing effective reach while integrating multiple channel options, trade areas/stores, unique budget constraints and various buying rules.

In some embodiments, the systems and methods described herein can integrate the optimization model with the execution of the media campaign, including one or more of launching a TV advertisement, displaying a billboard advertisement, printing and/or distributing print mail advertisements, changing aspects of a media campaign such as media channels, budgets or geographic areas, etc.

The systems and methods may further reduce wasted advertising spend that would not contribute to maximizing effective reach and instead merely contribute to wasted resources.

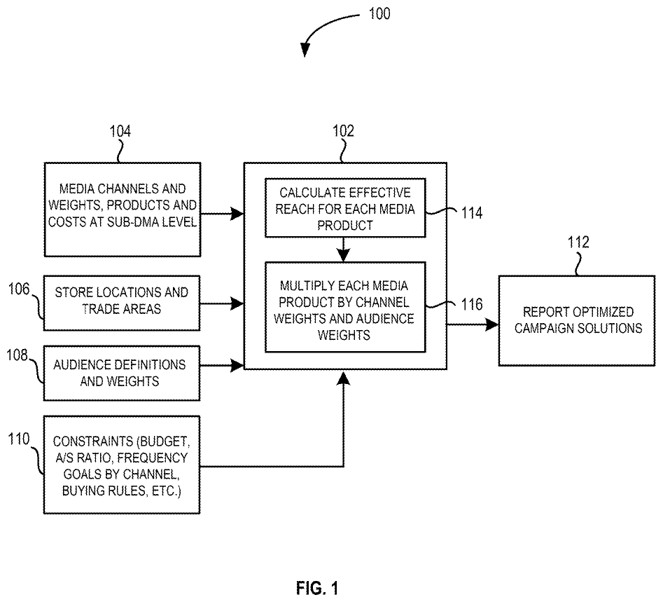

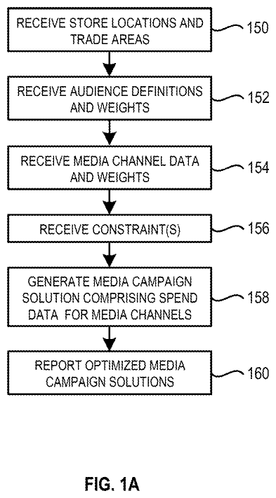

Referring to FIG. 1, systems and methods for optimizing a media campaign will be described. A flow diagram 100 illustrates a model which can be implemented as a system or a method in different embodiments. A solver 102 may be a program operating on a processing circuit which receives input data and generates one or more outputs or solutions. A solver may be a piece of mathematical software that receives problem descriptions and calculates their solutions. Solver 102 may comprise FICO Xpress Solver by Fair Isaac Corp., IBM ILOG CPLEX Optimizer by IBM Corp., Analytic Solver Optimization by Frontline Systems, Inc., or other solvers.

Solver 102 may receive media channel data 104 for a plurality of media channels, such as newspaper, direct mail, broadcast, radio, digital/web (e.g., connected television, such as streaming video services), social media (e.g., Facebook, Instagram, etc.) and Out of Home (e.g., billboards, bus stop signs, traditional signs). Each media channel may have one or more of an identifier of the channel (an alphanumeric code, name, number, etc.), a cost for advertising in the media channel, a geographic region that the media channel covers (e.g., a ZIP code, a range of addresses, one or more counties, etc.), and a weight for the media channel. The weight may be, for example, a whole number, decimal or fraction provided by an advertising entity who wishes to advertise for retail stores and may be based on factors such as past experience, syndicated media receptivity data, results of a measurement tool such as a media mix model, etc. The advertising entity (e.g., an ad agency, ad department, company, etc.) may be tasked with maximizing effective reach of advertising dollars for a set of retail locations, businesses, etc.

Effective reach may be the number of people or the percentage of an audience that receives an advertising message with a frequency equal to or greater than an effective frequency. Effective reach may refer to a target audience receiving the “minimum” effective exposure to an advertisement or campaign. Effective frequency may be the number of times a certain advertisement must be exposed to a particular individual in a given period to produce a desired response.

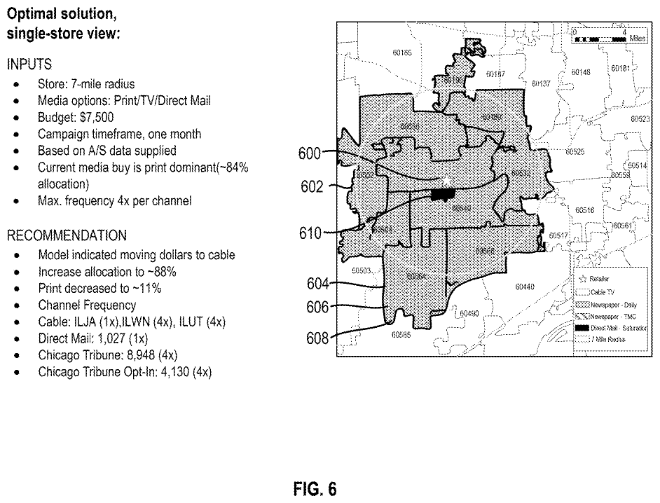

Solver 102 may receive store location data 106 for a plurality of retail stores. The location data may be in latitude/longitude, global positioning system coordinates, street address, etc. The retail stores may be stores associated with the advertising entity through business relationship or contract. Solver 102 may also receive one or more trade areas for the stores. A trade area may be a range (e.g., 1 mile, 0.25 miles, 10 miles, etc.) defined by an advertising entity to represent a distance within which to distribute advertisements via media channels. FIG. 6 illustrates a retail location having a trade area of 7 miles. A trade area may be a circle of a predetermined radius, a drive-time contour specified by maximum travel time, an arbitrary contour defined by where customers actually live, weighted by their value, or other trade areas. Store location 106 may comprise one or more trade areas for different sets of retail stores.

Solver 102 may receive audience definitions and weights 108 for one or more target audiences. An audience definition may comprise one or more criteria defining a target audience of current and/or prospective customers for the retail location. The audience definition may comprise one or more segments or demographic criteria, such as age range, gender, income range, etc. Each member of the audience is associated with location data, such as a home address. Audience weights may also be received by solver 102, the weights being defined by the advertising entity. The advertising entity may select the weights based on a strategic value of a segment, based on a propensity to shop model, based on historic spend, or simply as a way to explore relative reach and cost as the audience weights are varied. In one method, a user may run solver 102 sequentially, adjusting the weights of audience segments each time and analyzing reported results.

Solver 102 may receive constraints 110 which may comprise a budget, an advertising-to-sales ratio, a frequency goal for one or more channels, buying rules, etc. Solver 102 may be configured to maximize effective reach subject to these constraints. In some situations, the constraints preclude a solution. For example, if solver 120 is presented with 10 media products, each having a cost of more than $100, and an overall budget constraint of $90, solver 102 will return a “no solution” result at block 112.

Solver 102 may be configured to generate a media campaign solution based on one or more of the store location data, trade areas, audience definition, audience weights, media channel data and the constraints. A media campaign solution may comprise spend data for each of the plurality of the media channels. The media campaign solution may be reported on a display screen at block 112. The media campaign solution can comprise a number of data fields, such as dollar spend for each media tactic (as defined by channel, geography and/or audience) and/or media product, calculated effective reach, and any of the input data used for the media campaign solution The media campaign solution may be reported using one or more of a chart, a bar graph, a pie graph, a data table, etc. In tabular form the output represents a buying plan that can be executed upon by the advertiser's media agency.

In one embodiment, solver 102 may be configured to generate the media campaign solution by a method comprising calculating 114 effective reach for media products within each media channel and multiplying 116 the effective reach for each media product by channel weights and/or audience weights for customers within the geographic region for the media channel to provide weighted effective reach for each media product. The calculation may be done relative to the audience definition provided by the advertising entity. For example, independent of constraints and other options, a single media option may have some degree of overlap with a target audience. For example, if a TV media channel is bought for the entire Chicago DMA and the trade area represents only 10% of that area, solver 102 may be configured to calculate effective reach as audience weight*channel weight*10% of the TV audience for the Chicago DMA. In one exemplary embodiment, calculating effective reach for media products within each media channel may further comprise using a probabilistic overlap between the geographic regions of the media channels and the trade areas for each of the plurality of retail stores In the example above, the effective reach calculation is probabilistic in that the solver need not specify which households are in the 10%, just that 10% of the total audience in the Chicago DMA area will be counted in the effective reach calculation.

In another exemplary embodiment, generating the media campaign solution further comprises limiting the media campaign solution by a buying rule. For example, a newspaper may have a buying rule specifying that if you want to buy zip code 12345, you also must buy zip codes 23456, and 34567. Solver 102 may be configured to treat this requirement as a constraint or a buying rule that must be adhered to in finding a maximum effective reach.

Referring now to FIG. 1A, a method of optimizing a media campaign will be described, according to an exemplary embodiment. The method may operate as an optimizer program on a server-class computer system. The computer system may comprise a user interface comprising an input device (e.g., keyboard, touch screen, memory port such as a Universal Serial Bus port, network connection such as an Ethernet in communication with the Internet, disc drive, etc.) and one or more output devices (e.g., a display, a speaker, etc.). At a block 150, the method may comprise receiving store location data for a plurality of retail stores. In some embodiments, the store location data may be received via manual input or be formatted as a spreadsheet or other file format and received by the optimizer program. The method may further comprise receiving trade areas for each of the plurality of retail stores, which may be similarly input manually, formatted in a file, etc.

At a block 152, the method may comprise receiving an audience definition comprising a plurality of audience members and respective audience location data. The audience definition may further comprise audience weights provided by an advertiser.

At a block 154, the method may comprise receiving media channel data, which also may comprise media channel weights. The media channel data for the plurality of media channels may comprise one or more of a cost for the media channel, a geographic region for the media channel, a weight for the media channel, or other data regarding the medial channel or products within the media channel.

Any or all of trade areas, audience definitions and/or media products or media buying options within a media channel may be defined at sub-Designated Marketing Area levels. For example, a trade area may cover a range from a store location which encompasses an area smaller than a Designated Marketing Area within which the trade area is defined. A trade area may overlap two or more different Designated Marketing Areas. As another example, a media product such as a newspaper or cable channel may cover a single zip code or several zip codes which define an area smaller than a Designated Market Area within which the zip code or zip codes are defined.

At a block 156, the method may comprise receiving a constraint. The constraint may be selected from the group comprising a budget, a channel frequency, and/or a buying rule. Other constraints are contemplated. The constraint can be any of a variety of factors used by the optimizer program to limit results reported in the media campaign solution or solutions.

At a block 158, the method may comprise generating a media campaign solution based on one or more of the store location data, trade areas, audience definition, audience weights, medial channel data and the constraint or constraints. Each media campaign solution may comprise spend data for each of the plurality of the media channels. At a block 160, media campaign solutions may be reported, for example on a display screen of the display, using textual and/or graphical display items. The reported media campaign solutions may be used by advertisers or other users to optimize media campaigns. For example, in the example where at least one media channel is a print media channel, the method may further comprise selecting spend data for the print media channel based on the media campaign solution or solutions, printing print media based on the selected spend data at a print facility (e.g., using a web offset printing press, a digital printer, or other print machines), and distributing the print media to the trade areas (e.g., through direct mail, postal service, or other delivery systems). In other embodiments, media may be distributed using other channels, such as via printed newspaper, broadcast, radio, digital/web, billboards, bus stop signs, traditional signs, etc.

In some embodiments, block 158 may further comprise calculating effective reach for media products within each media channel based on the received data in blocks 150, 152, 154, and/or 156. The method may further comprise multiplying the effective reach for each media product by the weight for each media channel and the audience weights for customers within the geographic region for the media channel to provide weighted effective reach for each media product.

In some embodiments, block 158 may further comprise applying a plurality of constraints and maximizing effective reach subject to the plurality of constraints.

In some embodiments, block 158 may further comprise using a probabilistic overlap between a geographic region of one of the media channels and a trade area for one of the retail stores. In some embodiments, block 158 may further comprise using a deterministic overlap between a geographic region of one of the media channels and a trade area for one of the retail stores, such as where one of the media channels is specific to individual households and the audience definition is specified at the household level.

In some embodiments, block 158 may further comprise limiting the media campaign solution by a buying rule.

In some embodiments, the optimizer program of FIG. 1A may advantageously receive data and/or generate solutions on a sub-DMA level. A sub-DMA level means any geographic regions which are generally smaller than Designated Market Area regions in which local television viewings are measured by The Nielsen Company, LLC.

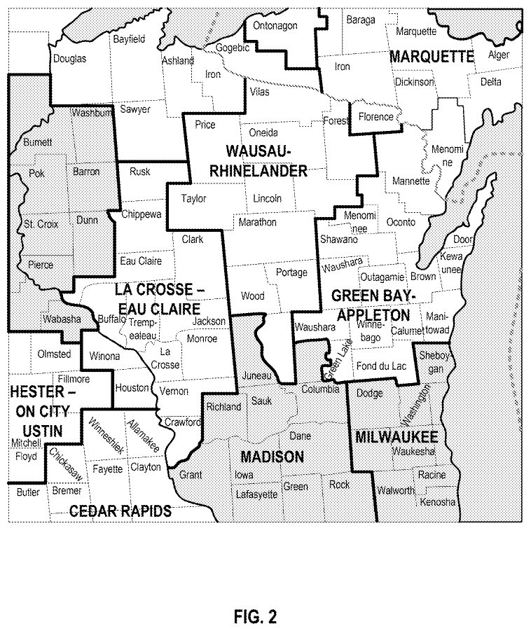

FIG. 2 is a portion of a map illustrating Designated Marketing Area regions. Each DMA has a name and a collection of neighboring counties. Some media products can be bought which distribute media to an entire DMA, e.g., at the DMA-level. Other media products can be bought which cover a smaller region, e.g., a sub-DMA level, such as a county or counties, a zip code or zip codes, etc.

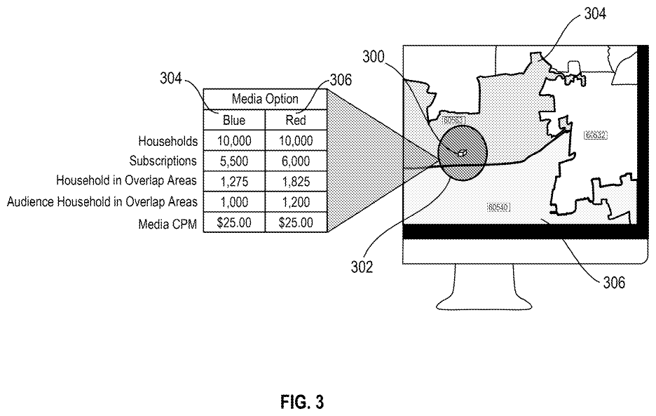

FIG. 3 is a diagram showing a retail store location 300, a trade area around the retail store location 302, and geographic coverage areas 304, 306 of two hypothetical media products, according to an exemplary embodiment. For example, red region 304 defines a geographical area at a sub-DMA level, enclosing a portion of a zip code representing 10,000 households, 6,000 of which households have a subscription to the media product, with a media cost per thousand of $25.00. Blue region 306 defines a geographical area at a sub-DMA level, enclosing a portion of a different zip code representing 10,000 households, 5,500 of which households have a subscription to the media product, with a media cost per thousand of $25.00. Trade area 302 is defined as a range from retail location 300 of X miles which overlaps both the red and blue geographic regions. Within the X mile trade area, 1,825 of the households in the red region are within trade area 302 and 1,275 of the households in the blue region are within the trade area 304.

The hypothetical example of FIG. 3 illustrates the complexities involved in generating an optimized media solution for retail locations with trade areas overlapping multiple geographical areas of media products. In many cases, the number of retail locations is numerous (e.g., at least 10, at least 50, at least 200, at least one thousand or thousands), each with respective trade areas that overlap different combinations of geographic areas for media channels. Considering there may be a number of different media channels and media products within each channel (television, Internet, newspaper, etc.), each having its own geographic area and different overlapping regions, the complexities can become practically unsolvable by pen-and-paper mathematics. Embodiments of the optimizer program may assist a user in identifying which combination of media options can provide the most effective reach, which ZIP codes, zones, stations, etc. offer the best reach, how much budget to move from one media channel to another media channel, which media channel best reaches a core or target audience, and/or other media optimization challenges. Embodiments of the optimizer program may perform numerous effective reach calculations, such as at least one hundred calculations, at least one thousand calculations, at least ten thousand calculations, etc.

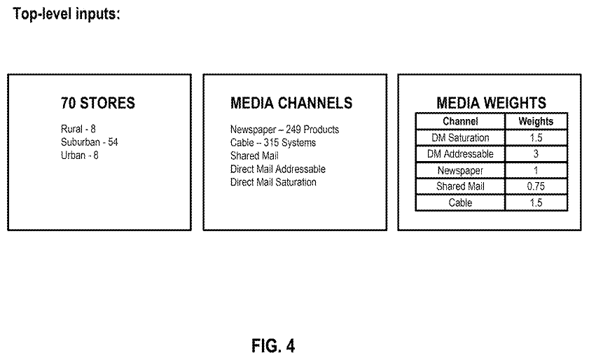

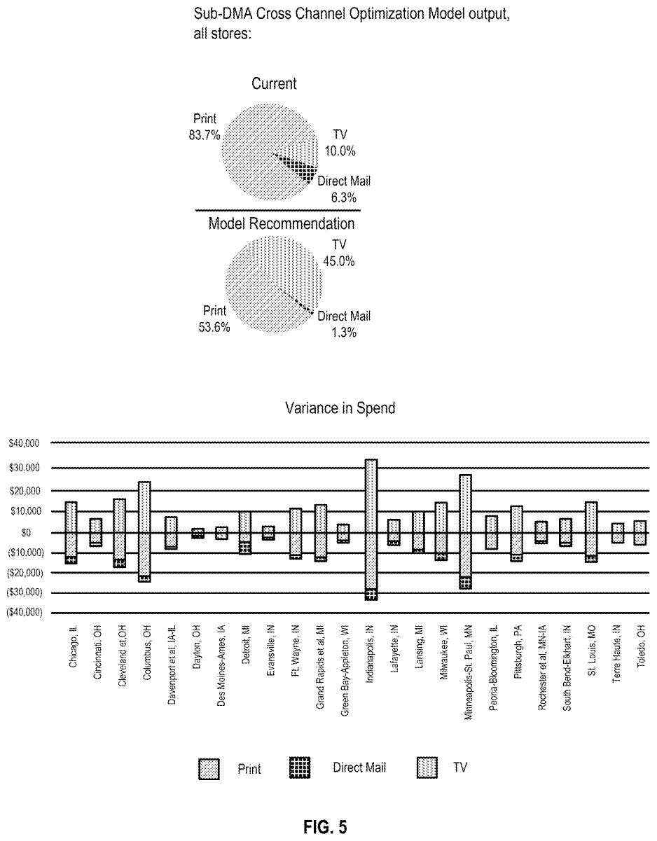

FIG. 4 is a diagram showing inputs for an example use of the system and method of optimizing a media campaign, according to an exemplary embodiment. In this example, store data is received for 70 stores. The store data includes a field indicating whether the store is in a rural location (eight), a suburban location (54) or an urban location (eight). The store data may also include store locations and trade areas defined enclosing the stores. Also in this example, media channel data includes data for 249 newspaper products, 315 cable TV systems, shared mail (print pieces shared by multiple different advertisers), direct mail addressable and direct mail saturation. An advertiser has assigned media weights of 1.5 to DM saturation, 3 to DM addressable, 1 to newspaper, 0.75 to shared mail and 1.5 to cable TV systems. This data is received by the optimization program and the solver performs the many effective reach calculations. The optimization program can be configured to generate the optimized media campaign solution shown in FIG. 5.

FIG. 5 is a set of pie charts and a graph illustrating an output of the system and method of optimizing a media campaign. The media campaign solution comprises a model recommendation of 53.6% print channels, 45.0% TV and 1.3% direct mail to maximize effective reach. This media campaign solution is optimized over the previous or “current” model of 83.7% print, 10.0% TV and 6.3% direct mail. The media campaign solution further comprises recommended increases and decreases in spend for each of print, TV and direct mail for each geographic region containing one of the stores. In this example, geographic regions are presented by city (e.g., Chicago, IL, Detroit MI, Lafayette, IN), though the media campaign solution may present the recommendations on other geographic levels, such as sub-DMA levels. To illustrate, the media campaign solution recommends increasing print channels spend in Dayton OH by a small amount and decreasing direct mail spend by a small amount. The media campaign solution recommends increasing direct mail spend in Des Moines-Ames, IA and decreasing print mail spend by small amounts.

FIG. 6 is a diagram showing inputs and recommendations for an optimized media campaign solution at a single-store view. FIG. 6 shows a single retail store location 600, a trade area around the retail store location 602, and geographic coverage areas of a plurality of media channels and media products, as well as model inputs and a recommendation, according to the exemplary embodiment of FIG. 4. As can be seen from FIG. 6, a trade area 602 for this retail store is input as a 7-mile radius or range. Media options in this range include cable TV 604, newspaper-daily 606, newspaper-TMC (total market coverage) 608, having substantial overlap with newspaper-daily, and direct mail-saturation 610. One constraint used in the example is a budget of $7,500. A campaign timeframe is set to one month. The campaign timeframe can be set to different periods. For example, where each buying option is available for a one month period, the campaign timeframe may be set to one month. Another constraint is a frequency-per-channel constraint of 4 times to prevent the solution from proposing 5 or more pieces being distributed in a given channel in the campaign timeframe.

FIG. 6 also summarizes recommendations provided by the optimization program or model. The model indicated moving dollars from direct mail and print to cable TV at this location, to increase allocation of budget to cable TV to about 88% and to decrease allocation of budget to print to about 11%. Regarding channel frequency, the model recommended one ad to cable channel ILJA, four ads to cable channel ILWN, four ads to cable channel ILUT, one direct mail ad to 1,027 households, four ads to the Chicago tribune representing 8,948 households and four ads to the Chicago tribune opt-in representing 4,130 households. The model has estimated that using this media campaign solution will maximize effective reach based on the inputs received.

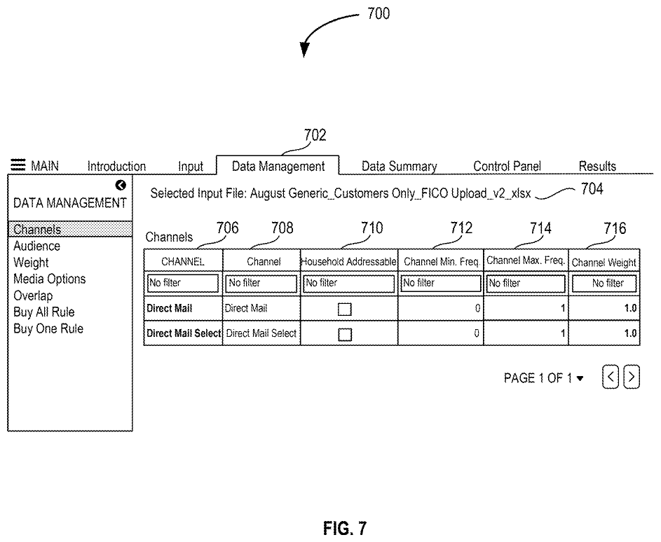

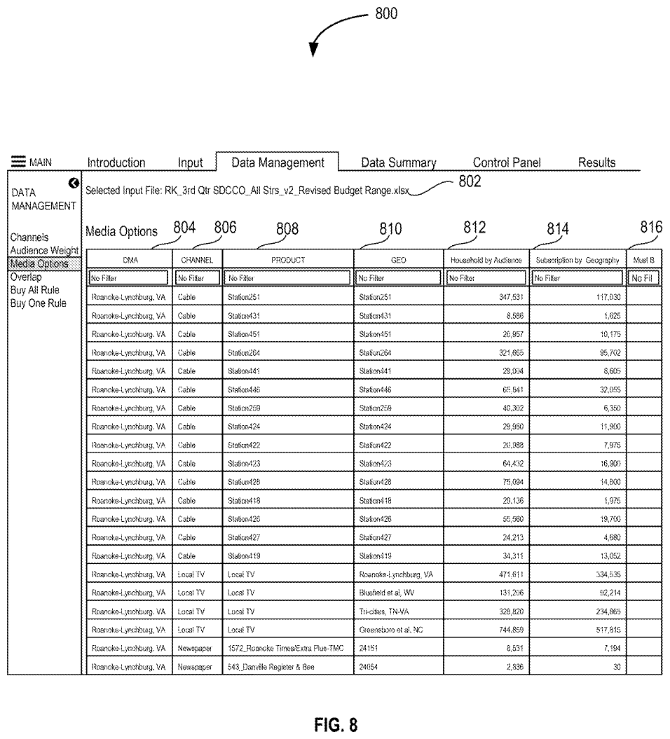

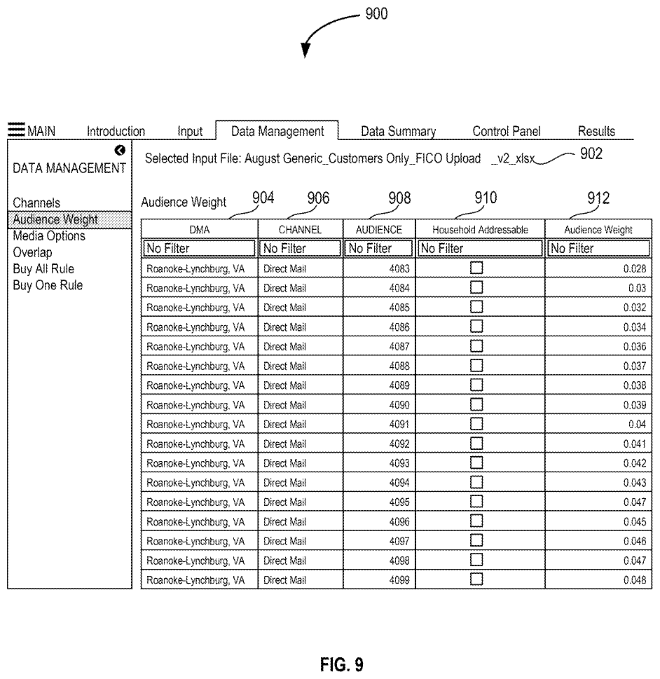

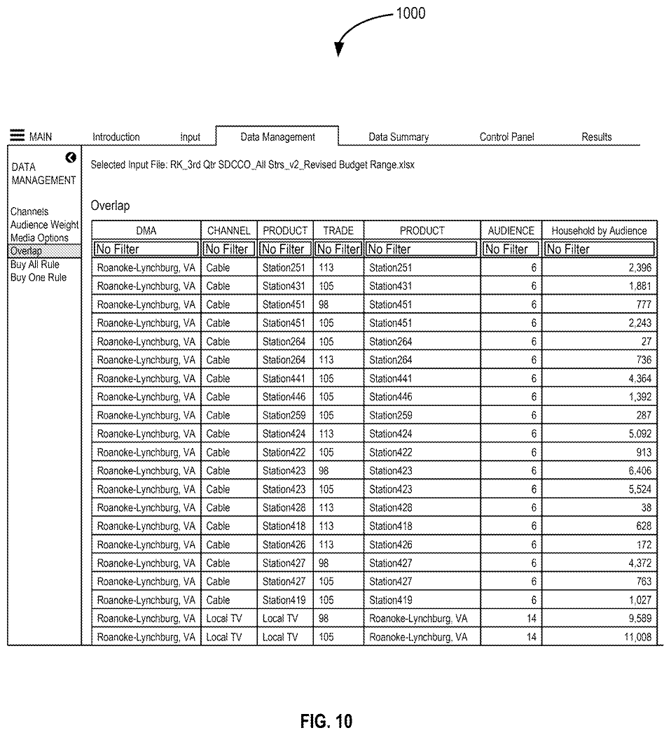

FIG. 7 is a screenshot of a user interface screen showing a Channels page, according to an exemplary embodiment. In some embodiments, an optimizer program as described herein may be configured to generate a user interface screen such as the Channels screen 700 shown in FIG. 7. Channels screen 700 is one of several screens under a Data Management heading and tab 702. The optimizer program may be configured to provide other screens when selected, including an Audience Weight screen (FIG. 9), a Media Options screen (FIG. 8), an Overlap screen (FIG. 10), a Buy All Rule screen and a Buy One Rule screen.

An input field 704 is generated by the optimizer program to allow a user to select from memory an input file having media channel data, such as media product identifiers, costs, etc. When selected and/or uploaded to the optimizer program, Channels screen displays channel data from the file. The channel data may comprise a channel category 706, a channel name 708, an indication 710 as to whether the channel is household addressable (e.g., print mail, newspapers, etc.), any frequency constraints in the channel data such as channel minimum frequency 712 and channel maximum frequency 714, and any channel weight data 716 from the file. Channel screen 700 provides an input mechanism for receiving media channel data for the solver of the optimizer program.

Referring to FIG. 8, the optimizer program may be configured to provide a Media Options screen 800. Media Options screen 800 may comprise an input field configured to receive a file selection from a user. The file may be the same file as on the Channels screen 700 or a different file, depending on the contents of the file and the configuration of the optimizer program. Media options screen 800 may be configured to display data from the file including, for each media option or media product, a Designated Market Area field 804 indicating a DMA within which the product is offered, a channel field 806 indicating the channel associated with the product (e.g., cable TV, local TV, newspaper, etc.), a product field 808 with a product identifier or name (e.g., Station 251, 1572 Roanoke Times, etc.), and a geographic area field 810 with an identifier or name of a geographic coverage area of the product on a DMA or sub-DMA level (e.g., Cable station 251, local TV station Bluefield et al, WV, newspaper 24054 associated with Danville Register & Bee, etc.). The data my further comprise a number of households 812 reached by the channel, a number of subscriptions by geography filed 814, and any associated constraints such as an associated Must Buy product 816 (e.g., if Station 251 is purchased, then Station 441 may also be required to be purchased). Additional fields are contemplated in other embodiments.

Referring to FIG. 9, the optimizer program may be configured to provide an Audience Weight screen 900 to display received audience weights for different audience definitions. Audience weight screen 900 may present an input field 902 to a user for selecting and/or uploading a data file to the optimizer program. The data may comprise a DMA field 904 indicating a DMA associated with the audience, a channel associated with the audience (e.g., direct mail), and an audience identifier 908. The audience identifier may comprise a number or other textual or graphical indication associated with an audience definition or segment. For example, audience ID 4083 may be associated with an audience in a certain geographic area, of a certain age range, of a certain gender, of a certain household income range, and/or other segments. A household addressable field 910 indicates whether the audience associated with the audience ID is household addressable. An audience weight field 912 indicates a weight assigned to the audience associated with the audience ID. The audience weights can be received from the input file and/or the screen can be configured to receive weights from a user through an input device.

Referring to FIG. 10, the optimizer program may be configured to provide an Overlap screen 1000. Overlap screen 1000 may be configured to display an outcome of a first round of computations. Specifically, a given trade area may have an overlap, as defined by a number of households, with a media option. These overlaps then serve as an input to the optimizer because when multiplied by channel and audience weights, the result represents effective reach for that particular option.

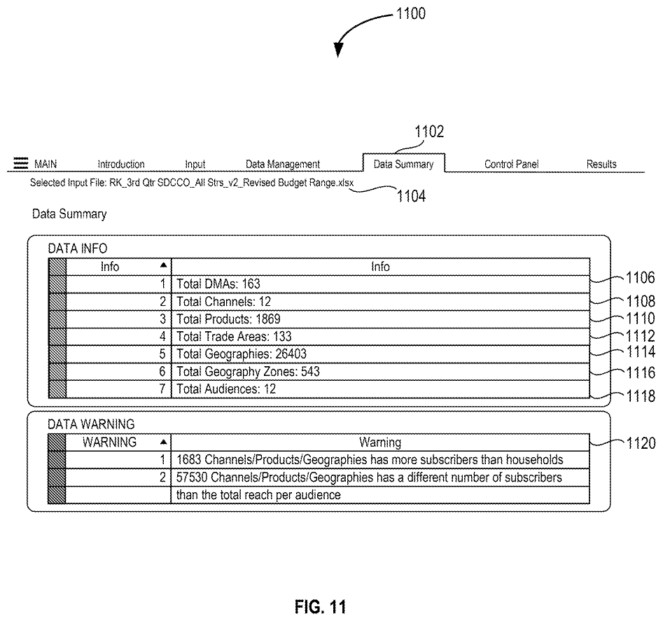

FIG. 11 is a screenshot of a Data Summary user interface screen 1100. A Data Summary tab 1102 can be selected by a user to display one or more summaries of the data received from the input file or input files 1104. For example, the Data Summary screen can show the total number of DMAs 1106 represented by the data that has been input, the total number of media channels 1108, the total number of media products 1110, the total trade areas 1112, the total geographies 1114, the total geography zones 1116 and the total audience definitions 1118. If there are any anomalies or other issues identified by the optimizer program regarding the data, the optimizer can be configured to display an indication of warnings in a data warning screen 1120. For example, if any of the media channels or products has more subscribers than households, a warning can be displayed. Data Summary screen 1100 may provide a summary of the inputs to will the optimizer program.

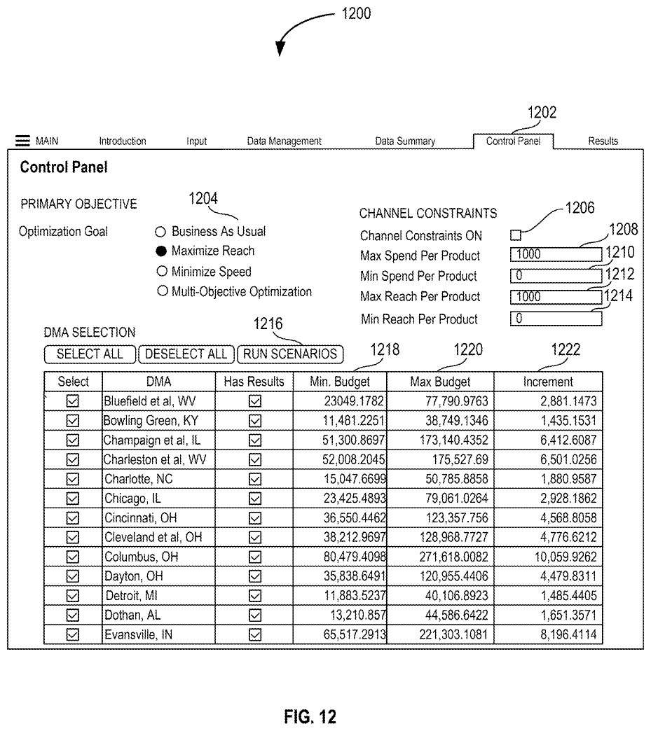

FIG. 12 is a screenshot of a user interface screen showing a Control Panel screen 1200, which can be displayed by the optimizer program when a user selects a Control Panel tab 1202 at the top of the screen. The optimizer program can be configured to receive one or more objectives, goals, constraints, or other data from the Control Panel tab. For example, a user may select from a plurality of radio buttons 1204 to input to the optimizer program whether the optimization goal is to maximize effective reach, minimize spend, conduct business as usual (if current spend data is input), or to have a multi-object optimization. The optimizer program may further be configured to receive an indication of whether any channel constraints are on at a checkbox 1202. If checked, the optimizer program will base the solution on constraints such as maximum spend per media product 1208, minimum spend per media product 1210, maximum reach per media product 1212, and/or minimum reach per media product. 1214. Other constraints can be input using this screen.

The Control Panel screen 1200 comprises a Run Scenarios button 1216 configured to receive a request from a user to apply the solver to the inputs and constraints received. The scenarios can be run for all DMAs within the input data (by selecting all DMAs) or for a subset of the DMAs (by selecting them individually). The solver may be configured to generate one or more media campaign solutions as described herein. For each DMA, a minimum budget field 1218 is shown, a maximum budget field 1220 is shown, and an increment field 1222 is shown. The minimum budget, maximum budgets and increments may be provided as user inputs to the optimizer program, allowing the user to explore how optimal effective reach varies as the budget ranges from a first percentage to a second percentage (e.g., 60% to 150%) of current budget in predetermined increments (e.g., 10%).

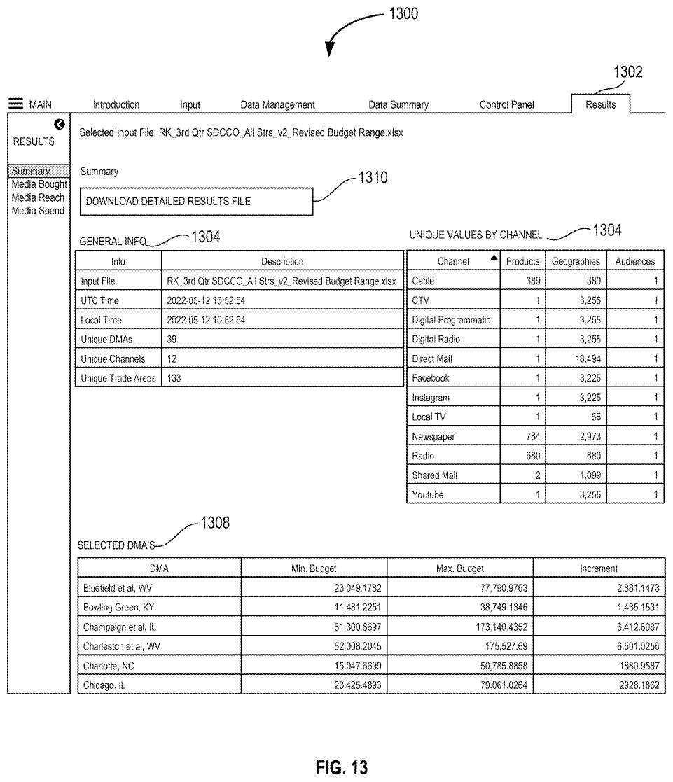

FIG. 13 is a screenshot of a user interface screen showing a Summary page 1300, according to an exemplary embodiment. A user may reach the Summary page by selecting a Results tab 1302 at the top of the screen. The Summary page 1300 may display one or more media campaign solutions and/or data associated therewith. For example, a General Information portion 1304 can display the name of the input file that was used to receive the input data for store data, audience data, media channel data, weights, etc. General Information portion 1304 may also include the number of unique DMAs represented by the input data, a number of unique channels represented by the data, and a number of unique trade areas represented by the data.

A unique value by channel portion 1306 can show, for each channel, the number of products in the input data, the number of geographies in the input data, and the number of audiences in the input data. A selected DMAs portion 1308 may be configured to display a minimum budget, a maximum budget, and an incremental budget for each of the DMAs selected at the Control Panel screen 1200.

A download detailed results button 1310 can be selected by the user to download detailed data for the media campaign solution generated, the data comprising budget to spend per channel, per product, etc. The downloaded results can comprise spend data for each of a plurality of media channels, media products, etc.

In some embodiments, the methods described herein may be run iteratively to incorporate the performance of one media campaign solution into the calculation of the next media campaign solution. The method may include deploying the optimization program, delivering the media campaign solutions as output data from the program, executing media placement based on the output data, agile learning, reviewing and refreshing the data, and then again deploying the updated optimization program to continue the cycle.

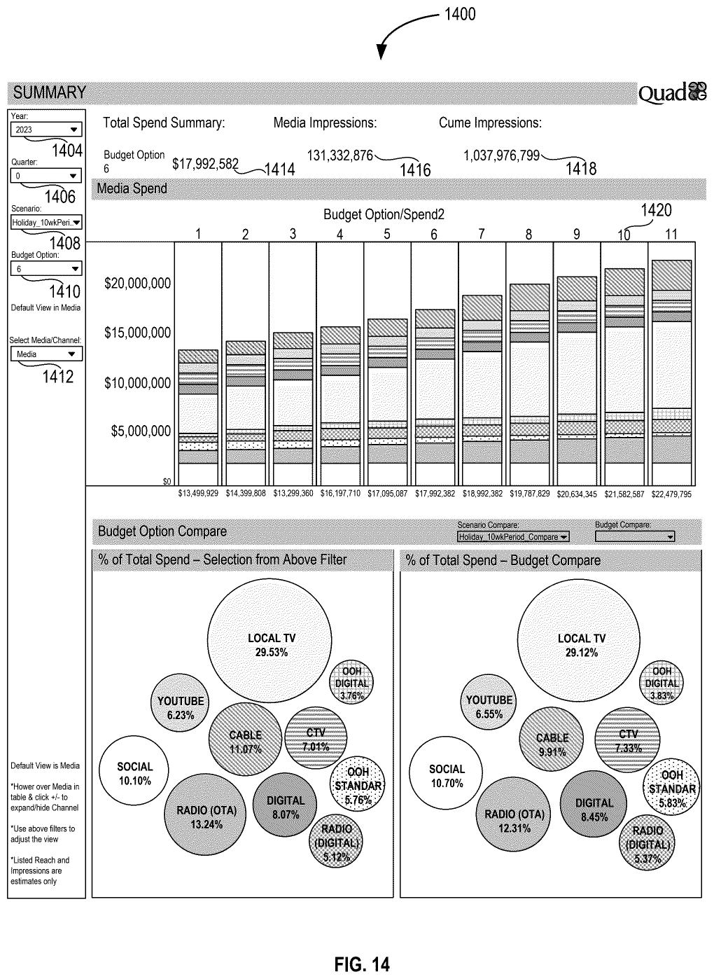

Referring now to FIGS. 14-17, a system and method for implementing a cross-channel, localized media campaign will be described. As described above, a solver has access to a database comprising various input data such as media channels, weights for media channels, media products within the media channels, costs for the media channels, retail store locations, trade areas, audience definitions, weights for audience definitions, constrains (e.g., one or more of budget, advertising/sales ratio, frequency goals by channel, buying rules, etc.), and/or other input data. The solver may be configured to generate data to generate a Summary page user interface screen such as that shown in FIG. 14. In some embodiments, media channels (e.g., cable television, radio over-the-air, digital radio, Youtube, social media, local television, print mail such as direct mail, etc.) may comprise at least two different media channels (in one example a print media channel and in another example a non-print media channel), at least five different media channels, etc. In some embodiment, a single media channel may comprise at least a dozen media products within the channel (e.g., WTMJ, WISN, etc. within local television), at least fifty media products, at least 100 media products, etc. Summary page 1400 may display drop-down menus 1402 for receiving additional filters, such as budget year 1404, budget quarter 1406, scenario title 1408, budget option 1410 within a range of budget options (e.g., 1 through N), selected media channel 1412, etc. Based on these selection, the solver may be configured to generate, for the selected budget option, a total spend summary 1414, a number of media impressions 1416, and a cumulative impressions number 1418. In another field 1420, the system may be configured to generate bar graphs illustrating an amount of budget for each budget option allocated by the solver to each media channel. These allocations of the selected budget to each media channel are based on the optimization engine of the solver described herein.

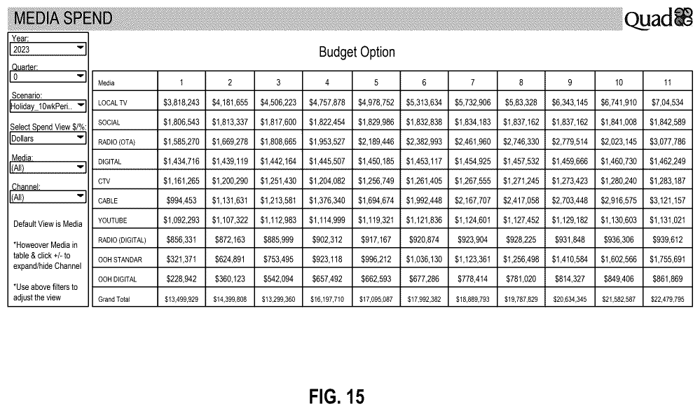

At a next step, the system may be configured to receive updated market-level budgets. As shown in FIG. 15, a Media Spend user interface screen may be configured to display the channel-level budgets for each budget option, allowing a user to provided one or more additional constraints in the form of channel-level or market-level budgets. The solver may then take those constraints and re-run the optimization across all channels.

At a next step, the system may be configured to receive a user request to view budget/media spend allocations at a DMA level. For example, for a Alpena, Michigan DMA, the solver has allocated $7,672 dollars to cable television 1602, $26,630 to local television 1604 and nothing to radio over-the-air 1606. Another DMA may be allocated different budget amounts for one or more of the channels. This view gives a user an opportunity to confirm the allocations across channels within each market are strategically acceptable.

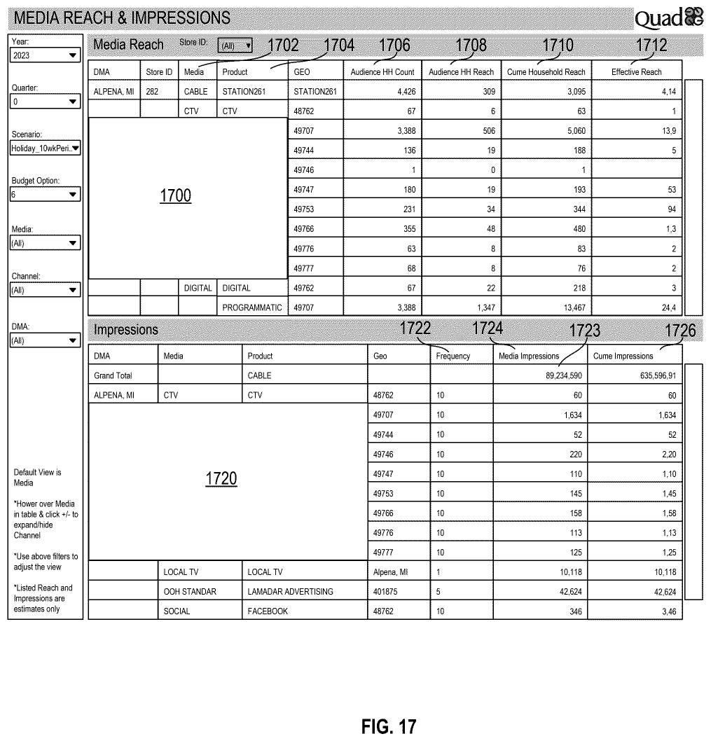

At a next step, the market-specific channel allocations may be published, transmitted, transferred, or otherwise communicated to agencies responsible for executing the media plan. For example, the budget allocation for Youtube can be sent (automatically, manually, etc.) to an advertising agency responsible for buying and uploading ads to Youtube for viewing. A budget allocation for print media can be sent to an ad agency or directly to a print company for use in printing advertisements to be mailed and delivered to consumers' mailboxes. Transmission of the budget allocations may further comprise providing or using consumer information (e.g., demographics, addresses, geographic areas, etc.) to instruct the agencies of the target audience for the advertisements. In some embodiments, the buying recipe may be distributed for each market, for each channel, and/or for each buying option within the channel to the appropriate agencies. FIG. 17 is a screenshot of a user interface screen showing a Media Reach and Impressions page, viewable by a user in response to selection thereof. A media reach field 1700 displays media channels 1702 and media products within each channel 1704 based on the optimized solution. For example, in the Alpena, MI DMA, connected television (CTV) may have a plurality of different products for reaching different users within the DMA and each product may be allocated a number of household counts 1706, household reach 1708, cumulative household reach 1710, and effective reach 1712. An impressions field 1720 may list a frequency 1722 of impressions for each product within the media channel, a number of media impressions 1724 for each total (and grand total 1723), and a cumulative impressions for each media product within the channel and DMA.

As shown at least in FIGS. 14-17, methods and systems herein may provide an optimized media spend plan or program, or a product selector, that can be viewed, adjusted, and/or implemented by one or more advertising agencies to carry out an advertising campaign. The advertising campaign can be cross-channel of numerous channels and have specificity at a localized level, giving instructions for individual products within channels that are sub-DMA or cross-DMA. In some existing advertising campaigns, localized advertising needs (e.g., a retailer losing business to a competitor in the southeast region) would be addressed by a single-channel, national solution such as buying more national television advertisement. The methods and systems described herein can, in some embodiments, help a user visualize and plan solutions to advertising needs that are localized by providing a tangible market allocation plan for execution by advertising entities. Different media spend allocations can be made for different products within or across DMAs or within major cities, counties, etc. In some embodiments, the market allocation plan can advise an increase in spending in one zip code with a decrease in spending in another zip code, even a neighboring zip code, due to different audience definitions and/or weights, store locations and/or areas, effective reach calculations, etc. In some embodiments, questions on an advertising product level (cable TV, Station 123) can be answered not only with “buy” or “don't buy,” but also with an amount to spend on advertising at the product level. In some embodiment, thousands of different products may be accounted for in the market allocation plan or media campaign solution, making manual calculation of the permutations unworkable.

In one specific application of the methods and systems described herein, printed mail pieces can be printed with advertisements for a media campaign in a quantity determined by a media spend allocation generated by the methods and systems described herein.

In another specific application, connected television advertisements, radio advertisements, and printed media pieces can be run in accordance with the media spend allocations provided by the optimized media campaign solution generated as described herein.

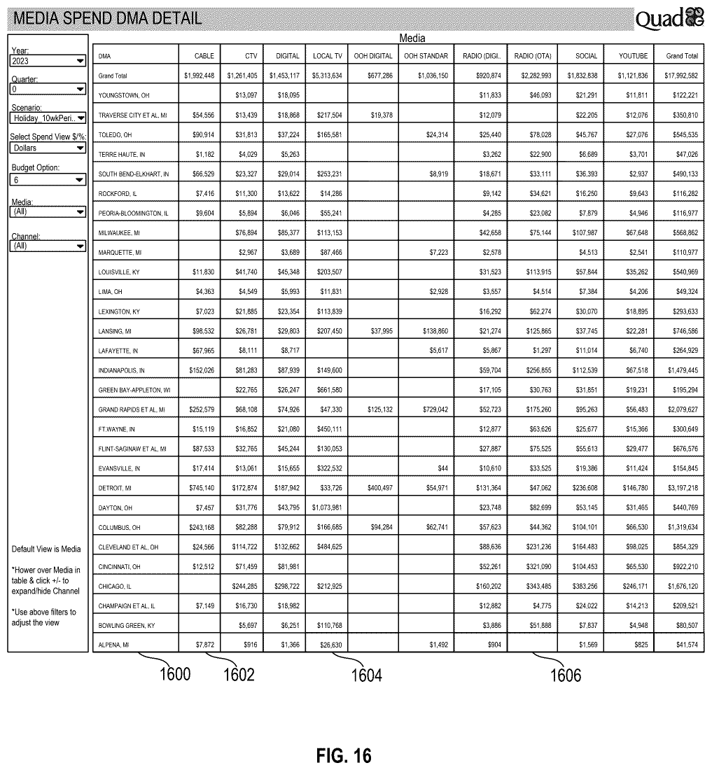

In another specific application, a media campaign solution may be generated comprising cross-channel, product-level media spend allocations such as those shown in FIG. 16 to enable one or more advertisers, retailers, print companies, or other users to implement an optimized media campaign which can reduce wasted budget and/or resources such as paper and delivery services.

The blocks described herein may operate on a computer, such as a desktop computer, server computer, etc. for operating the optimization program in its various embodiments described herein. In alternate embodiments, the systems and methods described herein may be implemented on a single server computer, a plurality of server computers, a server farm, a cloud server environment, or using other computer resources. The computers may comprise analog and/or digital circuit components forming processing circuits configured to perform the blocks and functions described herein. The processing circuits may comprise discrete circuit elements and/or programmed integrated circuits, such as one or more microprocessors, microcontrollers, analog-to-digital converters, application-specific integrated circuits (ASICs), programmable logic, printed circuit boards, and/or other circuit components. The computer may comprise a network interface circuit configured to provide communications over one or more networks with other devices. The network interface circuit may comprise digital and/or analog circuit components configured to perform network communications functions. The networks may comprise one or more of a wide variety of networks, such as wired or wireless networks, wide area-local-area or personal-area networks, proprietary or standards-based networks, etc. The networks may comprise networks such as an Ethernet network, networks operated according to Bluetooth protocols, IEEE 802.11x protocols, cellular (TDMA, CDMA, GSM) networks, or other network protocols. The network interface circuits may be configured for communication of one or more of these networks and may be implemented in one or more different sub-circuits, such as network communication cards, internal or external communication modules, etc.

According to one embodiment, storage of the input data described herein may be implemented on a database coupled to or part of a server. The database may be a DBMS hosted on a server host platform, such as Microsoft Windows XP, Microsoft Windows Server 2008, etc.

The computer may comprise one or more memories which can include any desired type of volatile and/or non-volatile memory such as, for example, static random access memory (SRAM), dynamic random access memory (DRAM), flash memory, read-only memory (ROM), etc. The memory can comprise a mass storage memory including any desired type of mass storage device including hard disk drives, optical drives, tape storage devices, etc.

An input/output controller can perform functions that enable a processor of the computer to communicate with peripheral input/output (“I/O”) devices and/or a network interface 530. The I/O devices can be, for example, a keyboard, a video display or monitor, a touch screen, a mouse, etc.

Certain embodiments contemplate methods, systems and computer program products on any machine-readable media to implement functionality described above. Certain embodiments can be implemented using an existing computer processor, or by a special purpose computer processor incorporated for this or another purpose or by a hardwired and/or firmware system, for example.

Some or all of the system, apparatus, and/or article of manufacture components described above, or parts thereof, can be implemented using instructions, code, and/or other software and/or firmware, etc. stored on a tangible machine accessible or readable medium and executable by, for example, a processor system. Tangible computer readable media include a memory, DVD, CD, etc. storing the software and/or firmware, but do not include a propagating signal.

As used herein, the term tangible computer readable medium includes any type of computer readable storage and excludes propagating signals. Additionally or alternatively, the example processes described herein may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information).

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described herein as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described herein should not be understood as requiring such separation in all embodiments, and it should be understood that the described program components and systems can generally be integrated together in a single product or packaged into multiple products.

Recitation in the claims of “a” or “an” element is to be construed as meaning “at least one” element and specifically includes within its scope a plurality of the recited element.

Particular embodiments of the subject matter have been described. Other embodiments are within the scope of the following claims.

1. A method of optimizing a media campaign, comprising:
receiving store location data for a plurality of retail stores;
receiving trade areas for each of the plurality of retail stores;
receiving an audience definition comprising a plurality of audience members and respective audience location data;
receiving audience weights;
receiving media channel data for a plurality of media channels, wherein at least one media channel is a print media channel, each media channel comprising a cost for the media channel, a geographic region for the media channel, and a weight for the media channel;
receiving a constraint, wherein the constraint is selected from the group comprising a budget, a channel or product frequency, and a buying rule;
using a solver operating on a tangible medium that receives problem descriptions and calculates solutions to the problem descriptions to generate a media campaign solution based on the store location data, trade areas, audience definition, audience weights, medial channel data and the constraint, the media campaign solution comprising spend data for each of the plurality of the media channels; and
displaying the spend data for the solution on a display screen;
selecting spend data for the print media channel for one of the media campaign solutions;
printing print media based on the selected spend data; and
distributing the print media to zones at a sub-designated market area level.

2. (canceled)

3. The method of claim 1, wherein generating the media campaign solution further comprises:
calculating effective reach for media products within each media channel;
multiplying the effective reach for each media product by the weight for each media channel and the audience weights for customers within the geographic region for the media channel to provide weighted effective reach for each media product.

4. The method of claim 3, wherein generating the media campaign solution further comprises:
applying a plurality of constraints; and
maximizing effective reach subject to the plurality of constraints.

5. The method of claim 3, wherein calculating effective reach for media products within each media channel further comprises:
using a probabilistic overlap between a geographic region of one of the media channels and a trade area for one of the retail stores.

6. The method of claim 3, wherein calculating effective reach for media products within each media channel further comprises:
using a deterministic overlap between a geographic region of one of the media channels and a trade area for one of the retail stores, wherein the one of the media channels is specific to individual households and the audience definition is specified at the household level.

7. The method of claim 1, wherein generating the media campaign solution further comprises:
limiting the media campaign solution by a buying rule.

8. (canceled)

9. The method of claim 1, wherein the audience definition, the trade areas and a media buying option of the media channel are all defined at sub-designated market area levels.

10. A system for optimizing a media campaign, comprising:
a user input device configured to provide user input data;
a memory configured to store the user input data;
a display device configured to display a media campaign solution; and
a processing circuit configured to:
receive store location data for a plurality of retail stores;
receive trade areas for each of the plurality of retail stores, the trade areas covering less than an area of a Designated Market Area;
receive an audience definition comprising a plurality of audience members and respective audience location data;
receive audience weights;
receive media product data for a plurality of different media products, each media product comprising a cost for the media product, a geographic region for the media product defined on a sub-Designated Market Area level, and a weight for the media product;
receive a constraint;
using a solver operating on the processing circuit that receives problem descriptions and calculates solutions to the problem descriptions to generate the media campaign solution based on the store location data, trade areas, audience definition, audience weights, medial product data and the constraint, the media campaign solution comprising spend data for each of the plurality of the media products; and
generate a display screen for the display device showing the spend data for the media campaign solution;
wherein at least one of the media products is a print media product, further comprising a printer configured to print the media product on a print medium in a quantity based at least in part on spend data for the print media product from the media campaign solution.

11. (canceled)

12. The system of claim 10, wherein the processing circuit is further configured to calculate effective reach for media products and multiply the effective reach for each media product by the weight for each media product and the audience weights for customers within the geographic region for the media product to provide weighted effective reach for each media product.

13. The system of claim 12, wherein the processing circuit is configured to apply a plurality of constraints and to maximize effective reach subject to the plurality of constraints.

14. The system of claim 13, wherein the processing circuit is configured to use a probabilistic overlap between a geographic region of one of the media products and a trade area for one of the retail stores.

15. The system of claim 14, wherein the processing circuit is configured to use a deterministic overlap between a geographic region of another of the media products and a trade area for another of the retail stores, wherein the another the media product is specific to individual households and the audience definition is specified at the household level.

16. The system of claim 15, wherein the audience definition, the trade areas and a media product are all defined at sub-designated market area levels.

17. (canceled)

18. (canceled)

19. (canceled)

20. (canceled)
